(19) United States
(12) Patent Application Publication
(10) Pub. No.: US 2025/0148392 A1
(43) Pub. Date: May 8, 2025

(54) METHOD FOR EVALUATING COST OF CLUSTER DATA RESOURCE, COMPUTER-READABLE STORAGE MEDIUM, AND ELECTRONIC DEVICE

(71) Applicant: Beijing Volcano Engine Technology Co., Ltd., Beijing (CN)

(72) Inventors: Wenchi ZHANG, Beijing (CN); Yaohua LI, Beijing (CN); Wenjie LI, Beijing (CN); Chao CUI, Beijing (CN); Hongbin LIU, Beijing (CN)

(21) Appl. No.: 18/939,752

(22) Filed: Nov. 7, 2024

(30) Foreign Application Priority Data
Nov. 7, 2023 (CN) 202311475452.0

(51) Int. Cl. G06Q 10/0631; G06F 9/50

(52) U.S. Cl. CPC G06Q 10/06315; G06F 9/5016; G06F 9/5027; G06F 2209/505; G06F 2209/508

(57) ABSTRACT

Embodiments of the present disclosure provide a method for evaluating a cost of a cluster data resource, a storage medium, and an electronic device. And the method includes: a storage evaluation index in a storage evaluation dimension and a computing evaluation index in a computing evaluation dimension for evaluating a cost of a cluster data resource are obtained. The data storage resource cost is evaluated based on an index value of the storage evaluation index, and the data computing resource cost is evaluated based on an index value of the computing evaluation index. In this way, invalid use and low-efficiency use in the cluster data resource are distinguished, so that the evaluation of the cost of the cluster data resource is more accurate.

### CROSS-REFERENCE TO RELATED APPLICATION

The present application claims the priority and benefits of Chinese Patent Application No. 202311475452.0, filed on Nov. 7, 2023, which is incorporated herein by reference in its entirety as part of the present application.

### TECHNICAL FIELD

The present disclosure relates to the field of computer technologies, and in particular, to a method for evaluating a cost of a cluster data resource, a computer-readable storage medium, and an electronic device.

### BACKGROUND

In a big data scenario, data-related services develop rapidly, and various service scenarios are implemented by means of cluster resources, such as cluster hardware resources. Hardware can be used to build services, undertake computing tasks, and meet requirements of various service scenarios.

A cost of a cluster data resource is used to represent a usage status of cluster hardware resources. In order to determine whether the usage of the cluster hardware resources is reasonable, a set of method for evaluating the cost of the cluster data resource is urgently needed at present.

### SUMMARY

The present disclosure provides a method for evaluating a cost of a cluster data resource, an apparatus, a computer-readable storage medium and an electronic device.

The present disclosure provides a method for evaluating a cost of a cluster data resource, and the method includes:
obtaining an evaluation dimension for evaluating the cost of the cluster data resource, in which the cost of the cluster data resource includes a data storage resource cost and a data computing resource cost, and the evaluation dimension includes a storage evaluation dimension and a computing evaluation dimension;
obtaining a storage evaluation index in the storage evaluation dimension and a computing evaluation index in the computing evaluation dimension, in which the storage evaluation index includes an invalid storage proportion of an invalid data storage resource cost in the data storage resource cost and a low-efficiency storage proportion of a low-efficiency data storage resource cost in the data storage resource cost, and the computing evaluation index includes an invalid computing proportion of an invalid data computing resource cost in the data computing resource cost and a low-efficiency computing proportion of a low-efficiency data computing resource cost in the data computing resource cost;
obtaining an index value of the storage evaluation index and an index value of the computing evaluation index; and
evaluating the data storage resource cost based on the index value of the storage evaluation index, and evaluating the data computing resource cost based on the index value of the computing evaluation index;
in which the invalid data storage resource cost is a data storage resource cost that satisfies a first storage condition, the low-efficiency data storage resource cost is a data storage resource cost that satisfies a second storage condition, the invalid data computing resource cost is a data computing resource cost that satisfies a first computing condition, and the low-efficiency data computing resource cost is a data computing resource cost that satisfies a second computing condition.

The present disclosure provides an apparatus for evaluating a cost of a cluster data resource, and the apparatus includes:
a first obtaining unit, configured to obtain an evaluation dimension for evaluating the cost of the cluster data resource, in which the cost of the cluster data resource includes a data storage resource cost and a data computing resource cost, and the evaluation dimension includes a storage evaluation dimension and a computing evaluation dimension;
a second obtaining unit, configured to obtain a storage evaluation index in the storage evaluation dimension and a computing evaluation index in the computing evaluation dimension, in which the storage evaluation index includes an invalid storage proportion of an invalid data storage resource cost in the data storage resource cost and a low-efficiency storage proportion of a low-efficiency data storage resource cost in the data storage resource cost, and the computing evaluation index includes an invalid computing proportion of an invalid data computing resource cost in the data computing resource cost and a low-efficiency computing proportion of a low-efficiency data computing resource cost in the data computing resource cost;
a third obtaining unit, configured to obtain an index value of the storage evaluation index and an index value of the computing evaluation index; and
an evaluating unit, configured to evaluate the data storage resource cost based on the index value of the storage evaluation index, and evaluate the data computing resource cost based on the index value of the computing evaluation index;
in which the invalid data storage resource cost is a data storage resource cost that satisfies a first storage condition, the low-efficiency data storage resource cost is a data storage resource cost that satisfies a second storage condition, the invalid data computing resource cost is a data computing resource cost that satisfies a first computing condition, and the low-efficiency data computing resource cost is a data computing resource cost that satisfies a second computing condition.

The present disclosure provides an electronic device, and the electronic device includes:
one or more processors; and
a storage apparatus having one or more programs stored thereon,
in which the one or more programs, when executed by the one or more processors, cause the one or more processors to implement the method for evaluating a cost of a cluster data resource.

The present disclosure provides a computer-readable storage medium having a computer program stored thereon, in which the computer program, when executed by a processor, causes the method for evaluating a cost of a cluster data resource to be implemented.

### BRIEF DESCRIPTION OF DRAWINGS

FIG. 1 is a flowchart of a method for evaluating a cost of a cluster data resource according to an embodiment of the present disclosure;

FIG. 2 is a schematic diagram of an evaluation dimension of a cost of a cluster data resource according to an embodiment of the present disclosure;

FIG. 3 is a schematic diagram of an index for evaluating a data storage resource cost according to an embodiment of the present disclosure;

FIG. 4 is a schematic diagram of an index for evaluating a data computing resource cost according to an embodiment of the present disclosure;

FIG. 5 is a schematic diagram of a structure of an apparatus for evaluating a cost of a cluster data resource according to an embodiment of the present disclosure; and

FIG. 6 is a schematic diagram of a basic structure of an electronic device according to an embodiment of the present disclosure.

### DETAILED DESCRIPTION

In order to make the above objectives, features, and advantages of the present disclosure more obvious and understandable, the following further describes embodiments of the present disclosure in detail with reference to the accompanying drawings and specific implementations.

In order to facilitate understanding of the present disclosure, the following describes a method for evaluating a cost of a cluster data resource provided in an embodiment of the present disclosure with reference to the accompanying drawings. For example, the method for evaluating the cost of the cluster data resource may be performed by a terminal device, a server, or the like, which is not limited here.

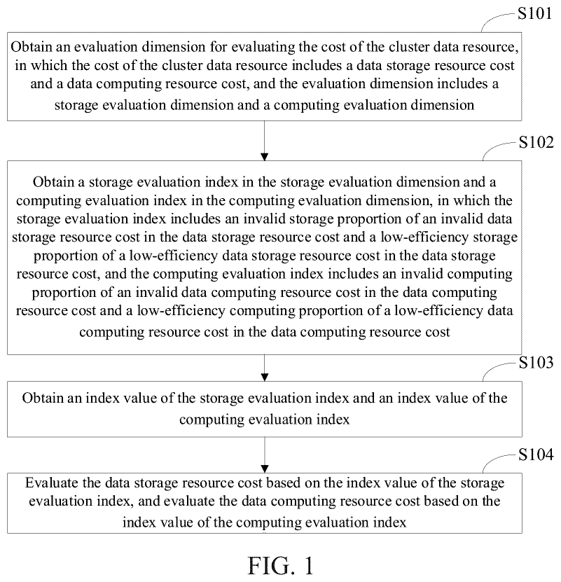

FIG. 1 is a flowchart of a method for evaluating a cost of a cluster data resource according to an embodiment of the present disclosure. As shown in FIG. 1, the method may include S101 to S104:

S101: Obtain an evaluation dimension for evaluating the cost of the cluster data resource, in which the cost of the cluster data resource includes a data storage resource cost and a data computing resource cost, and the evaluation dimension includes a storage evaluation dimension and a computing evaluation dimension.

Cluster hardware resources may include various resources such as a memory, a central processing unit, a disk, and a hard disk that are used to build services and undertake computing tasks. The central processing unit and other processing hardware devices may be used to implement various computing tasks, and the memory, the disk, the hard disk, and other storage hardware devices may be used to store data in a database, a partition, a data table, and the like. It can be learned that the implementation of a computing task in a cluster depends on the computing of devices such as the central processing unit, and the output of the computing task (for example, an output data table) depends on the storage of devices such as the memory and the disk.

Cluster data resources are quantized values corresponding to the cluster hardware resources (referred to as cluster hardware for short). The cluster data resources include data storage resources and data computing resources. The data storage resources are data resources used to store data, and may be represented by data storage space (a quantized value corresponding to the cluster hardware) of the cluster hardware such as the memory, the disk, and the hard disk. For example, when a disk has 80 GB of data storage space, 80 GB may be regarded as the data storage resources of the disk. The data computing resources are usable data resources used to output data, and may be represented by a time for which the cluster hardware such as the central processing unit can be used to output data (a quantized value corresponding to the cluster hardware).

The cost of the cluster data resource is cluster data resources that have been consumed or used, and the cost of the cluster data resource includes the data storage resource cost and the data computing resource cost. The data storage resource cost is data storage resources that have been consumed or used, and the data computing resource cost is data computing resources that have been consumed or used. For example, the data storage resources of the disk are 80 GB, and a data table output by a current computing task is stored in the disk, and uses 5 GB of data storage space. Therefore, the data storage resource cost of the data table is 5 GB. In another example, when the output data of the current computing task uses 10 h, 10 h is the data computing resource cost used by the computing task.

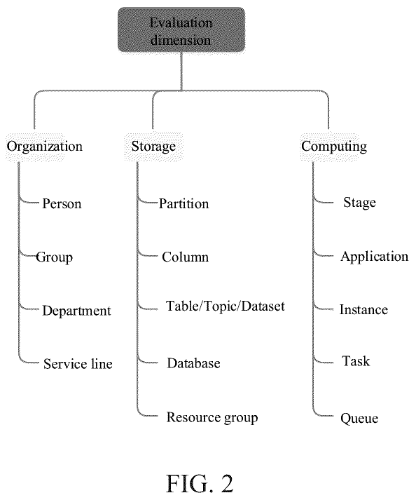

Based on this, the evaluation of the cost of the cluster data resource may be implemented through two dimensions: the evaluation of the data storage resource cost and the evaluation of the data computing resource cost. Therefore, the evaluation dimension of the cost of the cluster data resource may be divided into two evaluation dimensions: the storage evaluation dimension and the computing evaluation dimension, and the terminal device, the server, or the like first obtains the two evaluation dimensions. The storage evaluation dimension is used to evaluate the data storage resource cost, that is, to evaluate the usage of the stored data resources, and the computing evaluation dimension is used to evaluate the data computing resource cost, that is, to evaluate the usage of the computed data resources. The evaluation of the cost of the cluster data resource by the terminal device and/or the server may be understood as evaluating whether the use of the cluster data resource is reasonable. When the use of the cluster data resource is reasonable, the resource usage requirements are met. In addition, the cluster hardware resources, the cluster data resources, the cost of the cluster data resource, and the like in this embodiment of the present disclosure may be determined based on a dimension of a data resource user. FIG. 2 is a schematic diagram of an evaluation dimension of a cost of a cluster data resource according to an embodiment of the present disclosure. As shown in FIG. 2, the data resource user may be an organization, and the organization includes a person, a group, a department, and a service line. That is, the data resource user may be an individual, a group, a department, a service line, or the like. Therefore, when the data resource user is a department, the above cluster hardware resources and cluster data resources are total data resources allocated to the department, and the cost of the cluster data resource is data resources consumed or used by the entire department after receiving the total data resources allocated. Therefore, the cost of the cluster data resource of each department may be evaluated. The remaining data resource users are similar and will not be described here again.

As shown in FIG. 2, the data storage resource cost may include data resource costs in dimensions such as a partition, a column, a table, a topic, a dataset, a database, and a data resource group, and is represented by used data storage space in the dimensions such as the partition, the column, the table, the topic, the dataset, the database, and the data resource group. The data computing resource cost may include data resource costs in dimensions such as a stage, an application, an instance, a task, and a queue, and is represented by a time for which data output by the stage, the application, the instance, the task, the queue, and the like are used. For details, see the following.

S102: Obtain a storage evaluation index in the storage evaluation dimension and a computing evaluation index in the computing evaluation dimension, in which the storage evaluation index includes an invalid storage proportion of an invalid data storage resource cost in the data storage resource cost and a low-efficiency storage proportion of a low-efficiency data storage resource cost in the data storage resource cost, and the computing evaluation index includes an invalid computing proportion of an invalid data computing resource cost in the data computing resource cost and a low-efficiency computing proportion of a low-efficiency data computing resource cost in the data computing resource cost.

After obtaining the two evaluation dimensions, namely the storage evaluation dimension and the computing evaluation dimension, the terminal device and/or the server may further obtain an evaluation index for directly evaluating the cost of the cluster data resource. Specifically, a storage evaluation index in the storage evaluation dimension that is used to evaluate the data storage resource cost and a computing evaluation index in the computing evaluation dimension that is used to evaluate the data computing resource cost are determined.

The evaluation index (including the storage evaluation index and the computing evaluation index) is a core index and is a result type index. An index value of the evaluation index (including an index value corresponding to the storage evaluation index and an index value corresponding to the computing evaluation index) may directly indicate an evaluation result, and is used to intuitively reflect whether the use of the cluster data resource is reasonable or whether there is a problem.

For example, in the two dimensions, namely the storage evaluation dimension and the computing evaluation dimension, according to an actual usage status of the cluster data resource, the use is divided into effective use, low-efficiency use, and invalid use, so that an evaluation process of the cost of the cluster data resource is more refined. That is, the data storage resource cost in the storage evaluation dimension may be divided into an effective data storage resource cost, a low-efficiency data storage resource cost, and an invalid data storage resource cost. The effective data storage resource cost, the low-efficiency data storage resource cost, and the invalid data storage resource cost respectively reflect three levels of effective use of data storage resources (which may be referred to as effective storage, indicating normal and reasonable data resource usage), low-efficiency use (which may be referred to as low-efficiency storage, indicating that the utilization rate of data resources or output is low, and the utilization rate may be improved subsequently), and invalid use (which may be referred to as invalid storage, indicating that the output of data resources is completely invalidly used, and the data resource usage may be stopped subsequently). Data stored by using the effective data storage resource cost may be referred to as effectively stored data, and the effectively stored data may be referred to as hot data. Similarly, data stored in the low-efficiency storage may be referred to as cold data, and data stored in the invalid storage may be referred to as useless data. In addition, the data computing resource cost in the computing evaluation dimension may be divided into an effective data computing resource cost, a low-efficiency data computing resource cost, and an invalid data computing resource cost. The effective data computing resource cost, the low-efficiency data computing resource cost, and the invalid data computing resource cost respectively reflect three levels of effective use of data computing resources (which may be referred to as effective computing), low-efficiency use (which may be referred to as low-efficiency computing), and invalid use (which may be referred to as invalid computing).

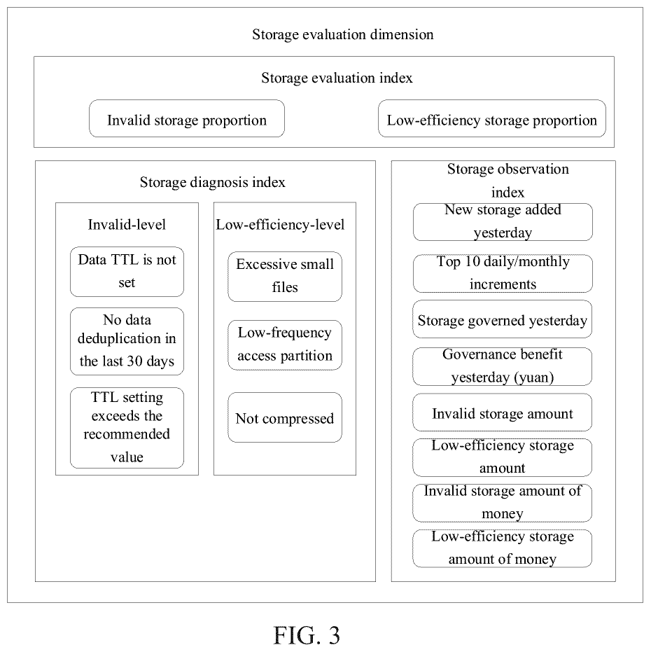

FIG. 3 is a schematic diagram of an index for evaluating a data storage resource cost according to an embodiment of the present disclosure. Based on the foregoing content, in combination with FIG. 3, the storage evaluation index may include an invalid storage proportion and a low-efficiency storage proportion. The invalid storage proportion is a proportion of the invalid data storage resource cost in the data storage resource cost, and the low-efficiency storage proportion is a proportion of the low-efficiency data storage resource cost in the data storage resource cost. The data storage resource cost may be determined based on a data resource user. When the data resource user is a department, the data storage resource cost herein is the data storage resource cost of the entire department.

For example, the invalid data storage resource cost is a data storage resource cost that satisfies a first storage condition, and the low-efficiency data storage resource cost is a data storage resource cost that satisfies a second storage condition. For example, the first storage condition is that a frequency at which data stored by using data storage resources is accessed is 0, and the second storage condition is that a frequency at which the data stored by using the data storage resources is accessed is greater than 0 and less than a target frequency. The target frequency is limited here. It should be understood that specific content of the first storage condition and the second storage condition is not limited here, and may be determined based on an actual situation.

It may be understood that the effective data storage resource cost may be considered as a reasonable data storage resource cost, and the effective data storage resource cost does not need to be considered when the data storage resource cost is evaluated.

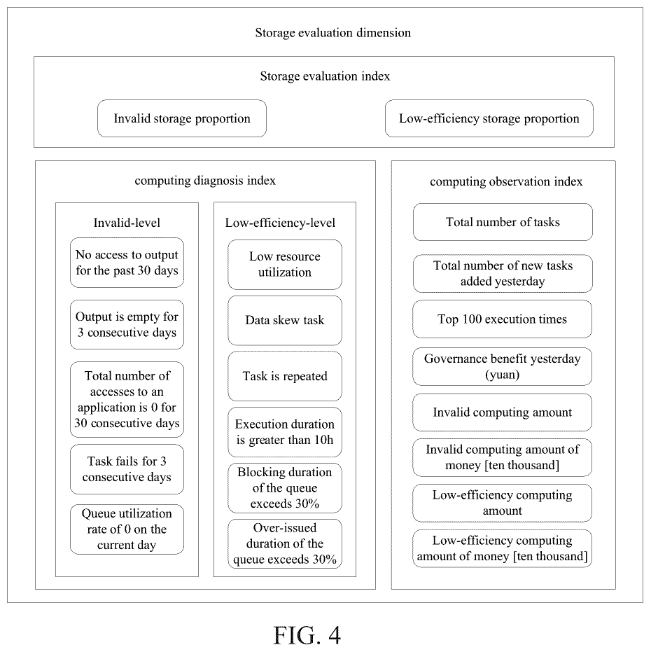

FIG. 4 is a schematic diagram of an index for evaluating a data computing resource cost according to an embodiment of the present disclosure. Based on the foregoing content, in combination with FIG. 4, the computing evaluation index may include an invalid computing proportion and a low-efficiency computing proportion. The invalid computing proportion is a proportion of the invalid data computing resource cost in the data computing resource cost, and the low-efficiency computing proportion is a proportion of the low-efficiency data computing resource cost in the data computing resource cost. When the data storage resource cost when the invalid storage proportion and the low-efficiency storage proportion are calculated is specifically the data storage resource cost of the entire department, the data computing resource cost herein is specifically the data computing resource cost of the entire department.

For example, the invalid data computing resource cost is a data computing resource cost that satisfies a first computing condition, and the low-efficiency data computing resource cost is a data computing resource cost that satisfies a second computing condition. For example, the first computing condition is that a frequency at which data output by using data computing resources is used is 0, and the second computing condition is that data computing resource usage efficiency is lower than a target efficiency. The target efficiency is not limited here. The data computing resource usage efficiency may be reflected by various indicators. For details, see the following. It should be understood that specific content of the first computing condition and the second computing condition is not limited here, and may be determined based on an actual situation.

It may be understood that when the data resource user is a department, the stored data, the output data, and the like are all data stored and data output internally by the department based on the department as a dimension. The remaining data resource users are similar and will not be described here again.

S103: Obtain an index value of the storage evaluation index and an index value of the computing evaluation index.

After obtaining the storage evaluation index and the computing evaluation index, the terminal device and/or the server may further obtain the index value of the storage evaluation index and the index value of the computing evaluation index. The index value of the storage evaluation index is a ratio of the invalid storage proportion and a ratio of the low-efficiency storage proportion, and the index value of the computing evaluation index is a ratio of the invalid computing proportion and a ratio of the low-efficiency computing proportion.

It may be learned that the invalid data storage resource cost and the data storage resource cost need to be determined first, and then the invalid storage proportion can be calculated. The invalid data storage resource cost and the data storage resource cost may be specifically an invalid data storage resource cost and a data storage resource cost inside a department. The remaining indicators are similar.

S104: Evaluate the data storage resource cost based on the index value of the storage evaluation index, and evaluate the data computing resource cost based on the index value of the computing evaluation index.

When the ratio of the invalid storage proportion and the ratio of the low-efficiency storage proportion are relatively large, it may be considered that the proportion of the data storage resource that is reasonably used is relatively large, that is, the proportion of the invalid storage and the low-efficiency storage is relatively large, there are many cases of invalid and low-efficiency storage of data, and the data storage resources of the data are not reasonably used. Similarly, when the ratio of the invalid computing proportion and the ratio of the low-efficiency computing proportion are relatively large, it may be considered that the proportion of the data computing resource that is reasonably used is relatively large, that is, the proportion of the invalid computing and the low-efficiency computing is relatively large, there are many cases of invalid and low-efficiency computing of data, and the data computing resources of the data are not reasonably used.

In a practical application, an evaluation score of the cost of the cluster data resource may be calculated, and the evaluation status of the cost of the cluster data resource, that is, whether it is reasonably used, is reflected by the evaluation score. For example, a weight may be allocated to the invalid storage proportion and the low-efficiency storage proportion, and a weighted summation is performed on the ratio of the invalid storage proportion and the ratio of the low-efficiency storage proportion, to calculate the evaluation score of the data storage resource cost. A weight is allocated to the invalid computing proportion and the low-efficiency computing proportion, and a weighted summation is performed on the ratio of the invalid computing proportion and the ratio of the low-efficiency computing proportion, to calculate the evaluation score of the data computing resource cost. Further, the evaluation score of the data storage resource cost and the evaluation score of the data computing resource cost are summed, to obtain the evaluation score of the cost of the cluster data resource.

Based on the related content of S101 to S104, it can be learned that the terminal device and/or the server evaluate the usage of the cost of the cluster data resource from the storage evaluation dimension and the computing evaluation dimension, so that the evaluation of the cost of the data resource is more reasonable and closer to an actual situation. Invalid storage and low-efficiency storage are distinguished in the data storage resource cost, and invalid computing and low-efficiency computing are distinguished in the data computing resource cost, so that the evaluation dimensions of the data storage resource cost and the data computing resource cost are more complete and rich, the evaluation of the cost of the cluster data resource is more accurate, and a user can more intuitively perceive the usage of the data resource cost. In addition, the method for evaluating the cost of the cluster data resource provided in this embodiment of the present disclosure may be automatically performed by the terminal device and/or the server, without consuming a large amount of labor costs, thereby improving evaluation efficiency.

The following provides a detailed description of a storage diagnosis index in the storage evaluation dimension and a computing diagnosis index in the computing evaluation dimension, to describe in detail, based on the storage diagnosis index and the computing diagnosis index, how to obtain an index value of the storage evaluation index and an index value of the computing evaluation index.

In a possible implementation, the method for evaluating the cost of the cluster data resource provided in this embodiment of the present disclosure further includes the following steps:
obtain a storage diagnosis index in the storage evaluation dimension and a computing diagnosis index in the computing evaluation dimension, in which the storage diagnosis index includes an invalid-level storage diagnosis index and a low-efficiency-level storage diagnosis index, and the computing diagnosis index includes an invalid-level computing diagnosis index and a low-efficiency-level computing diagnosis index.

The diagnosis index (including the storage diagnosis index and the computing diagnosis index) in this embodiment of the present disclosure is an index used for performing detailed determination on an evaluation index (the storage evaluation index and the computing evaluation index) to obtain an index value of the evaluation index, and is a process type index. Correspondingly, problem attribution may be implemented based on the diagnosis index.

For example, the above first storage condition is that the invalid-level storage diagnosis index is satisfied, the second storage condition is that the low-efficiency-level storage diagnosis index is satisfied. That is, a data storage resource cost that satisfies the invalid-level storage diagnosis index is the invalid data storage resource cost, and a data storage resource cost that satisfies the low-efficiency-level storage diagnosis index is the low-efficiency data storage resource cost. For example, the above first computing condition is that the invalid-level computing diagnosis index is satisfied, and the second computing condition is that the low-efficiency-level computing diagnosis index is satisfied. That is, a data computing resource cost that satisfies the invalid-level computing diagnosis index is the invalid data computing resource cost, and a data computing resource cost that satisfies the low-efficiency-level computing diagnosis index is the low-efficiency data computing resource cost.

The invalid-level storage diagnosis index includes an index used for representing that a usage rate of stored data is 0, and/or an index used for representing that the stored data does not satisfy a data storage rule. The low-efficiency-level storage diagnosis index includes an index used for representing that a usage rate of the stored data is less than a usage rate threshold, and/or an index used for representing that a storage type of data does not satisfy a target storage type. The invalid-level computing diagnosis index includes an index used for representing that the efficiency of output data of a task is less than first preset efficiency, and/or an index used for representing that a usage rate of the output data of the task is 0. The low-efficiency-level computing diagnosis index includes an index used for representing that the efficiency of the output data of the task is less than second preset efficiency, and the second preset efficiency is better than the first preset efficiency.

Based on the foregoing content, in combination with FIG. 3, the invalid-level storage diagnosis index may include one or more of the following:
a data table is not provided with a time to live, the total number of accesses to the data table within a preset period of time is 0, the total number of accesses to data in a database within the preset period of time is 0, the total number of accesses to data under a directory within the preset period of time is 0, and the time to live of the data table is greater than a recommended value.

Time To Live (TTL) is a time allowed for data to be stored in a data warehouse, or may be understood as a time allowed for data to be stored in a hard disk. In a practical application, data is stored by using a data table. A smaller TTL value set for the data table makes data updated more frequently, and more likely to increase a burden on a device. A larger TTL value set for the data table makes data stored for a longer time, and the stored data may be outdated. Therefore, the TTL of the data table needs to be set, and the TTL needs to be set to an appropriate value. Generally, a recommended value of the TTL may be given, and the value is an appropriate TTL value. The TTL value should be set in accordance with the recommended value of the TTL. Based on this, in this embodiment of the present disclosure, when the TTL value of the data table is not set or the set TTL value is greater than the recommended value, it indicates that the setting of the data table does not follow TTL setting rules of the data table, and it may be considered that data in the data table is invalidly stored data. Therefore, data storage resources used by the data table are data storage space of the data table, and the used data storage space is the invalid data storage resource cost. In addition, setting the TTL value in accordance with the recommended value may be considered as satisfying data storage rules, and “the data table is not provided with a time to live” and “the time to live of the data table is greater than the recommended value” may be considered as an index used for representing that the stored data does not satisfy the data storage rule.

In a practical application, the terminal device and/or the server first obtain the data table, and obtain a time to live corresponding to the data table. When the obtained time to live corresponding to the data table is empty, the terminal device and/or the server determine that the data table is not provided with a time to live.

In this embodiment of the present disclosure, when stored data is not used within a preset period of time, it is determined that the stored data is invalidly stored data without existence value, and data storage space used by the data is the invalid data storage resource cost. As an optional example, the preset period of time may be 30 days, and preset periods of time in different invalid-level storage diagnosis indices may be the same or different. The stored data may be divided into data stored in a data table, data stored in a database, data stored under a directory (for example, a directory in a file storage system HDFS), and the like. Therefore, that the data is not used within the preset period of time may be represented by “the total number of accesses to the data table within the preset period of time is 0”, “the total number of accesses to data in the database within the preset period of time is 0”, “the total number of accesses to data under the directory within the preset period of time is 0”, and the like. Based on this, “the total number of accesses to the data table within the preset period of time is 0”, “the total number of accesses to data in the database within the preset period of time is 0”, “the total number of accesses to data under the directory within the preset period of time is 0”, and the like may be considered as an index used for representing that the usage rate of the stored data is 0.

The data table is used as an example. In a practical application, the terminal device and/or the server first obtain the data table, and obtain (and may count) the total number of accesses to the data table within the preset period of time, and compare the total number of accesses with 0, to determine whether the total number of accesses to the data table within the preset period of time is 0.

It may be understood that as long as the stored data satisfies any one of the foregoing invalid-level storage diagnosis indices, it is considered that the data storage resource cost consumed by the data is the invalid data storage resource cost.

Based on the foregoing content, in combination with FIG. 3, the low-efficiency-level storage diagnosis index may include one or more of the following:
a total number of small files is greater than a target number, an access frequency of partition data is less than a target frequency, and stored data is not compressed.

When the access frequency of the partition data is not 0 and less than the target frequency, it is considered that the partition data is used but the frequency of use is low. In this way, it is determined that the partition data is low-efficiency stored data, and data storage space used by the partition data, that is, the low-efficiency data storage resource cost. It may be understood that “the access frequency of the partition data is less than the target frequency” may be considered as an index used for representing that the usage rate of the stored data is less than the usage rate threshold. The access frequency is used for representing the usage rate of the data, and the target frequency is used for representing the usage rate threshold.

In a practical application, the terminal device and/or the server first determine a partition, and then obtain the access frequency of data of the partition, and compare the access frequency of the partition data with the target frequency, to determine whether the access frequency of the partition data is less than the target frequency.

In addition, a small file is a file with a relatively small capacity. For example, the small file may be a file with a size of 1 KB. It may be understood that when there are excessive small files (for example, the total number of small files is greater than the target number, and the target number is not limited), it is considered that the data storage is relatively scattered, and it is determined that the storage manner is relatively inefficient, and data stored in the small files is low-efficiency stored data. In this way, it is determined that data storage space used by the small files, that is, the low-efficiency data storage resource cost. In addition, when some stored data should be compressed to save storage space but is not compressed, it is considered that the stored data occupies redundant data space. In this way, it is determined that data storage space used by the uncompressed stored data, that is, the low-efficiency data storage resource cost. It may be understood that “the total number of small files is greater than the target number and the stored data is not compressed” may be considered as an index used for representing that the storage type of the data does not satisfy the target storage type. A storage type in which the total number of small files is less than or equal to the target number and the stored data is compressed may be considered as the target storage type, which is only used as an example and does not constitute a limitation.

In a practical application, the terminal device and/or the server first obtain the total number of small files, and then compare the total number of small files with the target number, to determine whether the total number of small files is greater than the target number. In addition, the terminal device and/or the server directly obtain stored data to be determined whether it is compressed, and then determine whether the stored data is in a compressed state, to determine whether the stored data is compressed.

It may be understood that as long as the stored data satisfies any one of the foregoing low-efficiency-level storage diagnosis indices, it is considered that the data storage resource cost consumed by the data is the low-efficiency data storage resource cost.

It may also be understood that the foregoing invalid-level storage diagnosis index and the low-efficiency-level storage diagnosis index list some indices related to the data table, the database, the partition, and the like. As shown in FIG. 2, under the storage evaluation dimension, there may be some invalid-level storage diagnosis indices and low-efficiency-level storage diagnosis indices related to a column, a topic, a dataset, a data resource group, and the like, which may be set according to an actual situation.

Based on the foregoing content, in combination with FIG. 4, the invalid-level computing diagnosis index may include one or more of the following:
the total number of accesses to output by a task within a preset period of time is 0, the task normally ends within the preset period of time but the output is empty, the total number of accesses to a dashboard and/or an interface within the preset period of time is 0, the task fails within the preset period of time, and the usage rate of a task queue on the current day is 0.

The preset periods of time in the invalid-level computing diagnosis indices may be the same or different, and may be determined based on an actual situation.

“The total number of accesses to output by a task within a preset period of time is 0” may be exemplified as “no access to output for the past 30 days” in FIG. 4, that is, the preset period of time in this indicator is 30 days. Output by the task may be understood as output data, which may be represented as outputting a data table in which data is stored, which is only an example and is not limited to a data storage manner. It may be learned that when the total number of accesses to data generated by the task in the past 30 days is 0, it indicates that the output by the task is invalid and has no existence value. Therefore, it may be considered that the output by the task (that is, the data generated by the task) is invalidly computed data, and the data computing resources used by the output by the task are the invalid data computing resource cost.

In a practical application, the terminal device and/or the server first obtain the output by the task (such as the output data), and then obtain the total number of accesses to the output by the task within the preset period of time, and compare the total number of accesses with 0, to determine whether the total number of accesses to the output by the task within the preset period of time is 0.

“The task normally ends within the preset period of time but the output is empty” may be exemplified as “the output is empty for 3 consecutive days” in FIG. 4, that is, the preset period of time in this indicator is three days. It should be understood that when the task normally ends but the output is empty for three consecutive days, the execution of the task for three consecutive days is invalid. In this case, the data computing resources used by the execution of the task are the invalid data computing resource cost. For example, the task normally ends, and outputs data of August 20, but a partition name for storing the output data is wrongly written as August 8, resulting in no data of August 20 output by the task being stored in a partition in which the data of August 20 is stored, and the storage is empty.

In a practical application, the terminal device and/or the server first obtain a status of the task within the preset period of time, where the status includes a status of whether the task normally ends and a status of whether the output by the task is empty. In this way, it may be determined whether there is “the task normally ends within the preset period of time but the output is empty”.

“The total number of accesses to a dashboard and/or an interface within the preset period of time is 0” may be exemplified as “the total number of accesses to an application is 0 for 30 consecutive days” in FIG. 4, that is, the preset period of time in this indicator is 30 days. The application may refer to a visualization service dashboard in the application and/or an interface in the application. The dashboard is used to display an index value of some indicator, and the interface is used to access data. The application is not limited here. It should be understood that when there is no access to the dashboard and/or the interface for 30 consecutive days, it may be considered that there may be a problem with data in a related entire link, data displayed in the dashboard, data accessible through the interface, and the like are all invalidly computed, and it may be considered that the data computing resources used to obtain the data are the invalid data computing resource cost.

In a practical application, the terminal device and/or the server first obtain the total number of accesses to the dashboard and/or the interface within the preset period of time, and then compare the total number of accesses with 0, to determine whether the total number of accesses to the dashboard and/or the interface within the preset period of time is 0.

“the task fails within the preset period of time” may be exemplified as “the task fails for 3 consecutive days” in FIG. 4, that is, the preset period of time in this indicator is three days. It should be understood that when the task fails for three consecutive days, the execution of the task for three consecutive days is invalid. For example, a table name is wrongly written, resulting in unsuccessful task running. In this case, the data computing resources used by the execution of the task are the invalid data computing resource cost.

In a practical application, the terminal device and/or the server first obtain a running result of the task within the preset period of time, and determine whether the task fails within the preset period of time based on the running result.

As shown in FIG. 2, the task queue is one of the computing evaluation dimensions, and data computing resources configured for the task queue may be exemplified as 1000 cores of central processing units and 10 TB of memory. “The usage rate of the task queue on the current day is 0” indicates that the task queue is invalidly used, and corresponding data computing resources are the invalid data computing resource cost. In a practical application, the terminal device and/or the server first obtain the usage rate of the task queue on the current day, and compare the usage rate with 0, to determine whether the usage rate of the task queue on the current day is 0.

It may be understood that “the total number of accesses to output by a task within a preset period of time is 0” and “the total number of accesses to a dashboard and/or an interface within the preset period of time is 0” may be used as an index used for representing that the usage rate of the output data of the task is 0. “The task fails within the preset period of time”, “the usage rate of the task queue on the current day is 0”, and “the task normally ends within the preset period of time but the output is empty” may be used as an index used for representing that the efficiency of the output data of the task is less than the first preset efficiency. The first preset efficiency is not limited here.

Based on the foregoing content, in combination with FIG. 4, the low-efficiency-level computing diagnosis index may include one or more of the following:
data resource utilization rate is less than target data resource utilization rate, a data skew occurs in the task, task is repeated, a task execution duration is greater than a target duration, a proportion of a blocking duration of the task queue exceeds a target proportion, and a proportion of an overissued duration of the task queue exceeds a target proportion.

The “data resource utilization rate” is a ratio of a difference between an applied data resource amount and a used data resource amount to the applied data resource amount, and both the applied data resource amount and the used data resource amount may be a department applied data resource amount and a department used data resource amount with a department as a data resource user. Data resources herein are the data computing resources, and include a memory data resource, a central processing unit data resource, and the like. Therefore, the applied data resource amount is a memory data resource application amount and a central processing unit data resource application amount, and the used data resource amount is a memory data resource usage amount and a central processing unit data resource usage amount. For example, the memory data resource application amount is 10 GB, and the central processing unit data resource application amount is 8 central processing units. The memory data resource usage amount is 5 GB, and the central processing unit data resource usage amount is 4 central processing units. Low data resource utilization rate includes low memory data resource utilization rate and low central processing unit data resource utilization rate. It should be understood that when the data resource utilization rate is less than the target data resource utilization rate, it indicates that the data resources are over-applied. In this case, it may be considered that the applied data computing resources are the low-efficiency data computing resource cost. A specific value of the target data resource utilization rate is not limited here, and may be determined based on an actual scenario.

In a practical application, the terminal device and/or the server first obtain the data resource utilization rate in the foregoing manner, and then compare the data resource utilization rate with the target data resource utilization rate, to determine whether the data resource utilization rate is less than the target data resource utilization rate.

“The data skew occurs in the task” indicates that child tasks of the task have uneven time for outputting data, and data resources used by some child tasks are occupied for a long time. For example, there are 100 child tasks in a current task, and the current task is completed after the 100 child tasks are all completed. When 99 of the 100 child tasks can all be completed within one minute, but the remaining one child task needs to run for two hours to complete, it indicates that the data skew occurs in the task. The task having data skew causes low task running efficiency. In this case, it is determined that data computing resources used by the entire task are all the low-efficiency data computing resource cost.

In a practical application, the terminal device and/or the server first obtain the time for each child task of the task to output data, and analyze the time for each child task to output data, to determine whether there is a child task for which the time for outputting data exceeds a target time (for example, one hour), to determine whether the data skew occurs in the task.

“The task is repeated” indicates that there are repeated parts in constructed tasks, and the tasks are repeatedly processed, resulting in additional waste of data computing resources and data storage resources. For example, a first constructed task is to take three fields (fields a, b, and c) from a table A and put the three fields into a table B, and a second constructed task is to take four fields (fields a, b, c, and d) from the table A and put the four fields into a table C. It may be learned that the second task does not need to be constructed, and the field d may also be put into the table B through an instruction, so that the fields a, b, c, and d may all be obtained from the table B. In this example, the first task and the second task are considered as repeated tasks, resulting in additional waste of data computing resources and data storage resources. Therefore, when the task is repeated, it is determined that data computing resources used by the repeated tasks are all the low-efficiency data computing resource cost.

In a practical application, the terminal device and/or the server first determine task content of the plurality of tasks, and then analyze the task content of the plurality of tasks, to determine whether the task content in the plurality of tasks can be combined, to determine whether there is a task repetition.

“The task execution duration is greater than the target duration” indicates that the task runs for a long time, and occupies the data computing resources for a long time. In this case, the data computing resources used by the task are determined as the low-efficiency data computing resource cost. A specific value of the target duration is not limited here, and may be determined based on an actual scenario. For example, as shown in FIG. 4, the target duration is 10 h.

In a practical application, the terminal device and/or the server first obtain the task execution duration, and then compare the task execution duration with the target duration, to determine whether the task execution duration is greater than the target duration.

The “proportion of a blocking duration of the task queue” is a ratio of a total suspension duration of instances in the queue to a total running duration of the instances in the queue. It should be understood that when the proportion of the blocking duration of the task queue is greater than the target proportion, it indicates that the queue is severely blocked and there may be a problem with a task running manner. In this case, it is determined that data computing resources corresponding to the task queue are the low-efficiency data computing resource cost. A specific value of the target proportion is not limited here, and may be determined based on an actual scenario. For example, as shown in FIG. 4, the target proportion is 30%.

In a practical application, the terminal device and/or the server first obtain the total suspension duration of the instances in the queue and the total running duration of the instances in the queue, and calculate the proportion of the blocking duration of the task queue. Then, the proportion of the blocking duration of the task queue is compared with the target proportion, to determine whether the proportion of the blocking duration of the task queue exceeds the target proportion.

The “proportion of an overissued duration of the task queue” is a ratio of the total number of times when a total data resource applied for in the task queue at a time point is greater than a minimum guaranteed data resource to the total number of time points. It should be understood that some task queues may use data resources that exceed a configured data resource limit. For example, the data resources configured for the task queue are 1000 cores of central processing units and 10 TB of memory. It is allowed that the data resources used by the task queue exceed the configured data resource limit, and an overrun time when the data resources used by the task queue exceed the configured data resource limit is the overissued duration. When the proportion of the overissued duration of the task queue is greater than the target proportion, it indicates that the overissued duration of the task queue is relatively long, and the data computing resource applied for by the current task queue is unreasonable. Data computing resources of the task queue may be increased or tasks in the queue may be adjusted. In this case, it is determined that the data computing resources corresponding to the task queue are the low-efficiency data computing resource cost. A specific value of the target proportion is not limited here, and may be determined based on an actual scenario. For example, as shown in FIG. 4, the target proportion is 30%.

In a practical application, the terminal device and/or the server first obtain the total number of times when the total data resource applied for in the task queue at the time point is greater than the minimum guaranteed data resource and the total number of time points, and calculate the proportion of the overissued duration of the task queue. Then, the proportion of the overissued duration of the task queue is compared with the target proportion, to determine whether the proportion of the overissued duration of the task queue exceeds the target proportion.

It may be understood that “data resource utilization rate is less than target data resource utilization rate, a data skew occurs in the task, task is repeated, a task execution duration is greater than a target duration, a proportion of a blocking duration of the task queue exceeds a target proportion, and a proportion of an overissued duration of the task queue exceeds a target proportion” may be used as an index used for representing that the efficiency of the output data of the task is less than the second preset efficiency. The efficiency of the output data of the task may be used for representing the usage efficiency of the data computing resources.

It may also be understood that the foregoing invalid-level computing diagnosis index and the low-efficiency-level computing diagnosis index list some indices related to the task, the queue, and the like. As shown in FIG. 2, under the computing evaluation dimension, there may be some invalid-level computing diagnosis indices and low-efficiency-level computing diagnosis indices related to a stage, an application, an instance, and the like, which may be set according to an actual situation.

Based on the foregoing content, this embodiment of the present disclosure provides a specific implementation of obtaining the index value of the storage evaluation index and the index value of the computing evaluation index in S103, including:

A1: Determine the index value of the storage evaluation index based on the storage diagnosis index and a corresponding index value.

That is, it is determined whether the stored data satisfies the storage diagnosis index, to obtain an index value corresponding to the storage diagnosis index. Because the index value corresponding to the storage diagnosis index can represent the type of the stored data, that is, invalid data (invalidly stored data) and low-efficiency data (low-efficiency stored data), the invalid data storage resource cost and the low-efficiency data storage resource cost can be determined based on the corresponding index value. Further, the invalid storage proportion and the low-efficiency storage proportion can be calculated.

A2: Determine the index value of the computing evaluation index based on the computing diagnosis index and a corresponding index value.

That is, it is determined whether the task/queue or the like satisfies the computing diagnosis index, to obtain an index value corresponding to the computing diagnosis index. Because the index value corresponding to the computing diagnosis index can represent the usage type of the data computing resources, that is, invalid computing and low-efficiency computing, the invalid data computing resource cost and the low-efficiency data computing resource cost can be determined based on the corresponding index value. Further, the invalid computing proportion and the low-efficiency computing proportion can be calculated.

Specifically, in a possible implementation, this embodiment of the present disclosure provides a specific implementation of determining the index value of the storage evaluation index based on the storage diagnosis index and a corresponding index value in A1, including:

A11: Determine, based on the invalid-level storage diagnosis index and a corresponding index value, a data storage amount of invalid data in the cluster data resource, and determine, based on the low-efficiency-level storage diagnosis index, a data storage amount of low-efficiency data in the cluster data resource, in which the data storage amount of the invalid data is used for representing the invalid data storage resource cost, and the data storage amount of the low-efficiency data is used for representing the low-efficiency data storage resource cost.

Based on the foregoing content, on the basis of the listed invalid-level storage diagnosis index, it is determined whether the stored data satisfies the invalid-level storage diagnosis index, and a corresponding index value (the index value may be yes or no) is obtained. As long as any one of the invalid-level storage diagnosis indices is satisfied, it is determined that the data is invalidly stored, and the stored data is the invalid data. After all the invalid-level storage diagnosis indices are determined, the data storage amount of the invalid data is counted, that is, the invalid data storage resource cost. Similarly, the data storage amount of the low-efficiency data is counted, that is, the low-efficiency data storage resource cost.

A12: Determine a total data usage storage amount of the cluster data resource, in which the total data usage storage amount is used for representing the data storage resource cost.

A13: Determine a ratio of the data storage amount of the invalid data to the total storage amount as the ratio of the invalid storage proportion, and determine a ratio of the data storage amount of the low-efficiency data to the total storage amount as the ratio of the low-efficiency storage proportion.

It should be understood that the cluster data resource may be total data resources applied for by a department with the department as a data resource user. The total data usage storage amount may be data storage resources used by the entire department, representing the data storage resource cost. The stored data described in A11 may be various data stored in the department.

For example, data tables are all used for storing data in the department, and there are 100 data tables (that is, the cluster data resource) applied for by the department, and the data storage amount of each data table is 1 GB. The department uses 90 data tables (that is, data storage space corresponding to the 90 data tables is the total data usage storage amount, that is, the data storage resource cost). Through determination, it is found that 10 data tables satisfy the listed invalid-level storage diagnosis index, and data stored in the 10 data tables is the invalid data, so that the data storage amount of the invalid data is 10 GB. In addition, through determination, it is found that 30 data tables satisfy the listed low-efficiency-level storage diagnosis index, and data stored in the 30 data tables is the low-efficiency data, so that the data storage amount of the low-efficiency data is 30 GB. The total data usage storage amount of the department is 90 GB. Therefore, 10 GB/90 GB is the ratio of the invalid storage proportion, and 30 GB/90 GB is the ratio of the low-efficiency storage proportion.

It may be understood that the invalid storage proportion represents the wasted data storage resources, and the low-efficiency storage proportion represents the low-efficiency used data storage resources. Therefore, it can be learned about the data storage resource cost. The fewer the wasted data storage resources, the fewer the low-efficiency used data storage resources, the lower the data storage resource cost.

In addition, the storage diagnosis index may also be used for problem attribution of the data storage resource cost. It may be learned that in the foregoing determination process, the specific storage diagnosis index that is triggered is learned, so that a position where the data storage resources are not reasonably used can be determined, and problem attribution is implemented. For example, a data table A triggers the invalid-level storage diagnosis index of “the data table is not provided with a time to live”, and an index value is “yes”. Therefore, it can be determined that data stored in the data table A is the invalid data, the data table A is a storage position of the invalid data, and “the data table is not provided with a time to live” is problem attribution of the invalid data storage resource cost. In this way, after problem attribution is performed, it is convenient for a user to subsequently implement governance of the data storage resources.

In a possible implementation, this embodiment of the present disclosure provides a specific implementation of determining the index value of the computing evaluation index based on the computing diagnosis index and a corresponding index value in A2, including:

A21: Determine, based on the invalid-level computing diagnosis index and a corresponding index value, an invalid computing time of the cluster data resource, and determine, based on the low-efficiency-level computing diagnosis index, a low-efficiency computing time of the cluster data resource, in which the invalid computing time is used for representing the invalid data computing resource cost, and the low-efficiency computing time is used for representing the low-efficiency data computing resource cost, and the computing time is obtained from a central processing unit usage computing time and a memory usage computing time.

Based on the foregoing content, on the basis of the listed invalid-level computing diagnosis index, it is determined whether the task, the queue, or the like satisfies the invalid-level computing diagnosis index, and a corresponding index value (the index value may be yes or no) is obtained. As long as any one of the invalid-level computing diagnosis indices is satisfied, it is determined that the used data computing resources are the invalid data computing resources. After all the invalid-level computing diagnosis indices are determined, the invalid data computing resource cost is counted. Similarly, the low-efficiency data computing resource cost is counted.

For example, the data computing resource cost may be represented by using the computing time. The computing time may be understood as a unit for evaluating the size of the data computing resources used by a task/queue. The computing time is obtained from the central processing unit usage computing time and the memory usage computing time. Specifically, the larger of the central processing unit usage computing time and the memory usage computing time is taken as the computing time. It is determined that one central processing unit core used for one hour is counted as one computing time, and 4 GB of memory used for one hour is counted as one computing time. For example, a task uses one central processing unit core and 8 GB, and the task runs for one hour. Therefore, the central processing unit usage computing time is one computing time, the memory usage computing time is two computing times, and the computing time corresponding to the task is the larger of one computing time and two computing times, that is, two computing times.

In this way, when the data computing resources are the invalid data computing resources, the data computing resource cost corresponds to the invalid computing time; and when the data computing resources are the low-efficiency data computing resources, the data computing resource cost corresponds to the low-efficiency computing time.

A22: Determine a total data usage computing time of the cluster data resource, in which the total data usage computing time is used for representing the data computing resource cost.

A23: Determine a ratio of the invalid computing time to the total data usage computing time as the ratio of the invalid computing proportion, and determine a ratio of the low-efficiency computing time to the total data usage computing time as the ratio of the low-efficiency computing proportion.

It should be understood that the cluster data resource may be total data resources applied for by a department with the department as a data resource user. The total data usage computing time may be data computing resources used by the entire department, representing the data computing resource cost. The task, the queue, and the like described in A21 may be a task and a queue constructed in the department.

For example, only 100 tasks are constructed in the department to output data. It is determined whether each task can trigger the listed invalid-level computing diagnosis index and the low-efficiency-level computing diagnosis index. The tasks that trigger the invalid-level computing diagnosis index are counted, and the cumulative amount of computing time used by the plurality of tasks that trigger the invalid-level computing diagnosis index is determined as the invalid computing time. In addition, the tasks that trigger the low-efficiency-level computing diagnosis index are counted, and the cumulative amount of computing time used by the plurality of tasks that trigger the low-efficiency-level computing diagnosis index is determined as the low-efficiency computing time. The cumulative amount of computing time used by the 100 tasks is determined as the total data usage computing time. In this way, the ratio of the invalid computing proportion and the ratio of the low-efficiency computing proportion can be calculated.

The invalid computing proportion represents the invalidly used computing, and the low-efficiency computing proportion represents the low-efficiency used computing. Therefore, it can be learned about the data computing resource cost. The fewer the invalidly used data computing resources, the fewer the low-efficiency used data computing resources, the more reasonably used the data computing resource cost.

Similarly, the computing diagnosis index may also be used for problem attribution of the data computing resource cost, which will not be described again here. In this way, after problem attribution of the data computing resource cost is performed, it is convenient for a user to subsequently implement governance of the data computing resources.

It may be understood that when the data resource users are various departments, not only the total data usage storage amount and the total data usage computing time of each department can be learned, but also the invalidly used data storage resources, the low-efficiency used data storage resources, the invalidly used data computing resources, and the low-efficiency used data computing resources of each department can be obtained. Furthermore, after problem attribution is performed, governance of the data resources may also be performed, to save the data storage resources and the data computing resources, and reduce invalid and low-efficiency usage of the data resources.

Based on the foregoing content, the method for evaluating the cost of the cluster data resource provided in this embodiment of the present disclosure is a measurable and interpretable cluster data resource evaluation system. By using the evaluation method, it can be clearly learned about the effectively used cluster data resource and the invalid and/or low-efficiency used cluster data resource. In addition, the evaluation has process and result indicators, to accurately measure whether the data storage resource cost and the data computing resource cost are reasonably used.

In order to make the evaluation of the data storage resource cost and the data computing resource cost more fine-grained, this embodiment of the present disclosure provides an observation index. The observation index may also be referred to as a benefit index, and includes an auxiliary judgment or auxiliary decision type index, and a governance benefit type index. The observation index may be visually displayed on a dashboard.

Based on this, in a possible implementation, the method for evaluating the cost of the cluster data resource provided in this embodiment of the present disclosure further includes the following steps:
obtain a storage observation index in the storage evaluation dimension and a computing observation index in the computing evaluation dimension, in which the storage observation index includes an auxiliary judgment type index and/or a data storage resource governance type index of the data storage resource cost, and the computing observation index includes an auxiliary judgment type index and/or a data computing resource governance type index of the data computing resource cost; and
evaluate the data storage resource cost and the data computing resource cost in combination with the storage observation index and the computing observation index.

It may be learned that the observation index includes the storage observation index in the storage evaluation dimension and the computing observation index in the computing evaluation dimension. The observation index covers a wide range, and the data storage resource cost is evaluated with the aid of the storage observation index, and the data computing resource cost is evaluated with the aid of the computing observation index. The evaluation situation may be determined based on an index value of the observation index.

The storage observation index includes the auxiliary judgment type index of the data storage resource cost and/or the data storage resource governance type index. Based on this, as an optional example, in combination with FIG. 3, the storage observation index includes one or more of the following:
a data storage amount increment within adjacent period of time, a sequential growth rate of the data storage amount increment, a sorting result of the data storage amount increment within a preset period of time, a data storage amount of invalid data and/or low-efficiency data that has been governed within the preset period of time, a monetary value corresponding to the data storage amount of the invalid data and/or low-efficiency data that has been governed, a total data storage amount of the invalid data within the preset period of time, and a total data storage amount of the low-efficiency data within the preset period of time.

“A data storage amount increment within adjacent period of time” may be exemplified as “new storage added yesterday” in FIG. 3, that is, the adjacent period of time in this indicator are the day before yesterday and yesterday. “New storage added yesterday” is new data storage resource cost added yesterday, and specifically is a difference between a total data storage amount yesterday and a total data storage amount the day before yesterday. When the data resource user is a department, “new storage added yesterday” is specifically new data storage resource cost added yesterday by the department. Changes in an indicator value of “new storage added yesterday” may be used to determine whether a daily increment of the data storage amount is normal, to assist in determining whether the data storage resource cost is reasonably used.

The “sequential growth rate of the data storage amount increment” is a ratio of a difference between new storage added yesterday and new storage added the day before yesterday to the new storage added the day before yesterday. The “sequential growth rate of the data storage amount increment” may be used to represent a horizontal comparison of the daily increment of the data storage amount, to assist in determining whether the data storage resource cost is reasonably used.

The “sorting result of the data storage amount increment within a preset period of time” may be exemplified as “top 10 daily/weekly growth rates” in FIG. 3, that is, the preset period of time in this indicator may be daily or weekly, and the sorting result may be top 10. It may be understood that when the data resource user is a department, the sorting result may specifically be an increment of the data storage amount of the top 10 departments.

The “data storage amount of invalid data and/or low-efficiency data that has been governed within the preset period of time” is a data storage resource governance type index, and may be exemplified as “storage governed yesterday” in FIG. 3, that is, the preset period of time in this indicator is yesterday. For example, when a data table satisfies the invalid-level storage diagnosis index, the data table is an invalid table, and the data table may be deleted. In this case, it may be considered that invalid data in the data table is governed, and a data storage amount of the data table is the data storage amount of the invalid data that has been governed. For another example, there are 100 small files, each small file has a data storage amount of 1 KB, and a total data storage amount is 100 KB. Because the total number of the 100 small files is relatively large, it is considered that the storage of the 100 small files is low-efficiency storage, and a data storage amount of corresponding low-efficiency data is 100 KB. Furthermore, the 100 small files may be combined into one file, to implement governance of the low-efficiency data. After governance, the data storage amount of the one file is 100 KB, which may be considered as effective storage. Therefore, it may be considered that the data storage amount of the low-efficiency data that has been governed is 100 KB.

The “monetary value corresponding to the data storage amount of the invalid data and/or low-efficiency data that has been governed” is a data storage resource governance type index, and may be exemplified as “governance benefit yesterday” in FIG. 3, which corresponds to “the data storage amount of invalid data and/or low-efficiency data that has been governed within the preset period of time”. It may be considered that the data storage amount corresponds to a specific amount of money. Therefore, after the data storage amount that has been governed is determined, the amount of money corresponding to the data storage amount that has been governed can be calculated. For example, 1 GB of data storage amount corresponds to a unit price of 100 yuan. The amount of money corresponding to the data storage amount that has been governed may be considered as a benefit brought by the governance of the data storage resources of the invalid data and/or the low-efficiency data.

The “total data storage amount of the invalid data within the preset period of time” is “the invalid storage amount” shown in FIG. 3, and is a total storage amount that is invalidly used. The “total data storage amount of the low-efficiency data within the preset period of time” is “the low-efficiency storage amount” shown in FIG. 3, and is a total storage amount that is low-efficiency used. The preset period of time may be yesterday, which is not limited here. In addition, the storage observation index may further include the invalid storage amount of money and the low-efficiency storage amount of money shown in FIG. 3. The invalid storage amount of money is an amount of money corresponding to the invalid storage amount, and the low-efficiency storage amount of money is an amount of money corresponding to the low-efficiency storage amount. These indicators are displayed on the dashboard, so that the user can learn about related storage in detail.

The computing observation index includes an auxiliary judgment type index of the data computing resource cost and/or a data computing resource governance type index. Based on this, as an optional example, in combination with FIG. 4, the computing observation index includes one or more of the following:
a total number of tasks, an increment of a task amount within adjacent period of time, a sorting result of task execution durations, a computing time governance result within a preset period of time, an invalid computing time to be governed within the preset period of time, a low-efficiency computing time to be governed within the preset period of time, a monetary value corresponding to the invalid computing time to be governed within the preset period of time, and a monetary value corresponding to the low-efficiency computing time to be governed within the preset period of time. The computing time governance result includes the invalid computing time and/or the low-efficiency computing time that has been governed, and a monetary value corresponding to the invalid computing time and/or the low-efficiency computing time that has been governed.

The “total number of tasks” is a total number of tasks in a dimension of the data resource user, and is an auxiliary judgment type index of the data computing resource cost. For example, when the data resource user is a department, the “total number of tasks” is specifically a total number of tasks constructed by the department.

“An increment of a task amount within adjacent period of time” may be exemplified as “a total number of new tasks added yesterday” in FIG. 4, and is an auxiliary judgment type index of the data computing resource cost. The adjacent period of time in this indicator are the day before yesterday and yesterday. “A total number of new tasks added yesterday” is a total number of tasks in the dimension of the data resource user. For example, when the data resource user is a department, “a total number of new tasks added yesterday” is specifically a total number of new tasks added by the department yesterday.

The “sorting result of task execution durations” may be exemplified as “top 100 execution times” in FIG. 4, that is, the sorting result is task execution durations ranked in the top 100. The task execution duration is a difference between a task execution end time and a task start time. It may be understood that the longer the task execution duration, the more likely there is a problem with the corresponding data computing resource cost. The display of the top 100 task execution durations provides a governance direction of the data computing resource cost.

The computing time governance result is a data computing resource governance type index of the data computing resource cost. “The invalid computing time and/or the low-efficiency computing time that has been governed” may be exemplified as “the data computing resource amount governed yesterday”, indicating a total amount of the data computing resource cost governed yesterday. “A monetary value corresponding to the invalid computing time and/or the low-efficiency computing time that has been governed” may be exemplified as “governance benefit yesterday” in FIG. 4, indicating a total governance benefit corresponding to the data computing resource cost governed yesterday.

The “invalid computing time to be governed” may be exemplified as “the invalid computing amount” in FIG. 4, indicating a total amount of the remaining invalid data computing resources that have not been governed currently. “A monetary value corresponding to the invalid computing time to be governed” may be exemplified as “the invalid computing amount of money” in FIG. 4, indicating an amount of money obtained by converting the total amount of the remaining invalid data computing resources that have not been governed currently. “The low-efficiency computing time to be governed” may be exemplified as “the low-efficiency computing amount” in FIG. 4, indicating a total amount of the remaining low-efficiency data computing resources that have not been governed currently. “A monetary value corresponding to the low-efficiency computing time to be governed” may be exemplified as “the low-efficiency computing amount of money” in FIG. 4, indicating an amount of money obtained by converting the total amount of the remaining low-efficiency data computing resources that have not been governed currently. “The invalid computing time to be governed, the low-efficiency computing time to be governed, the monetary value corresponding to the invalid computing time to be governed, and the monetary value corresponding to the low-efficiency computing time to be governed” are a display of a current governable situation, and are the data computing resource governance type index of the data computing resource cost.

A person skilled in the art may understand that in the foregoing method of the specific implementation, the writing sequence of the steps does not mean a strict execution sequence, and does not constitute any limitation on the implementation process, and the specific execution sequence of the steps should be determined by their functions and possible internal logic.

On the basis of the implementations provided in the foregoing aspects, the present disclosure may be further combined to provide more implementations.

Based on the method for evaluating the cost of the cluster data resource provided in the foregoing method embodiment, this embodiment of the present disclosure further provides an apparatus for evaluating the cost of the cluster data resource. The apparatus for evaluating the cost of the cluster data resource will be described below with reference to the accompanying drawings. Because the apparatus in the embodiments of the present disclosure solves the problem by using a similar principle to the method for evaluating the cost of the cluster data resource in the foregoing embodiments of the present disclosure, for implementation of the apparatus, reference may be made to the implementation of the method, and details will not be described again.

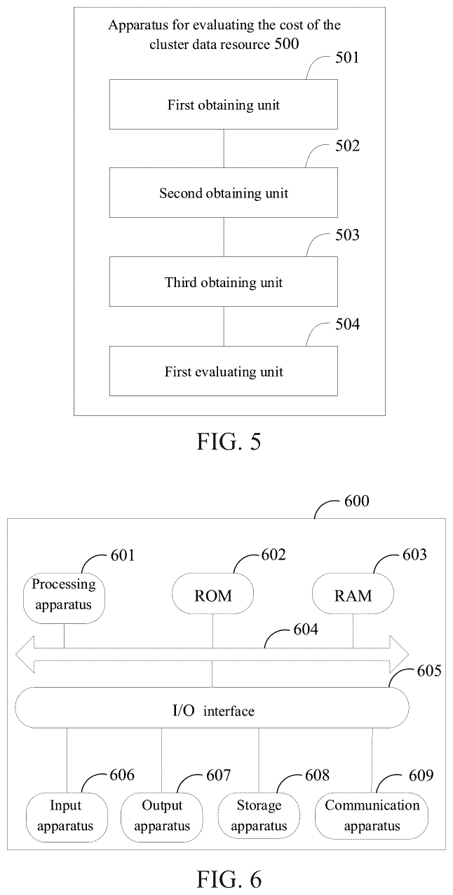

Referring to FIG. 5, FIG. 5 is a schematic structural diagram of an apparatus for evaluating the cost of the cluster data resource according to an embodiment of the present disclosure. As shown in FIG. 5, the apparatus for evaluating the cost of the cluster data resource 500 includes:
a first obtaining unit 501 is configured to obtain an evaluation dimension for evaluating the cost of the cluster data resource, in which the cost of the cluster data resource includes a data storage resource cost and a data computing resource cost, and the evaluation dimension includes a storage evaluation dimension and a computing evaluation dimension;
a second obtaining unit 502 is configured to obtain a storage evaluation index in the storage evaluation dimension and a computing evaluation index in the computing evaluation dimension, in which the storage evaluation index includes an invalid storage proportion of an invalid data storage resource cost in the data storage resource cost and a low-efficiency storage proportion of a low-efficiency data storage resource cost in the data storage resource cost, and the computing evaluation index includes an invalid computing proportion of the invalid data computing resource cost in the data computing resource cost and a low-efficiency computing proportion of the low-efficiency data computing resource cost in the data computing resource cost;
a third obtaining unit 503 is configured to obtain an index value of the storage evaluation index and an index value of the computing evaluation index;
a first evaluating unit 504 is configured to evaluate the data storage resource cost based on the index value of the storage evaluation index, and evaluate the data computing resource cost based on the index value of the computing evaluation index; and
in which the invalid data storage resource cost is a data storage resource cost that satisfies a first storage condition, the low-efficiency data storage resource cost is a data storage resource cost that satisfies a second storage condition, the invalid data computing resource cost is a data computing resource cost that satisfies a first computing condition, and the low-efficiency data computing resource cost is a data computing resource cost that satisfies a second computing condition.

In a possible implementation, the apparatus further includes:
a fourth obtaining unit is configured to obtain a storage diagnosis index in the storage evaluation dimension and a computing diagnosis index in the computing evaluation dimension, in which the storage diagnosis index includes an invalid-level storage diagnosis index and a low-efficiency-level storage diagnosis index, and the computing diagnosis index includes an invalid-level computing diagnosis index and a low-efficiency-level computing diagnosis index;
the first storage condition is that the invalid-level storage diagnosis index is satisfied, the second storage condition is that the low-efficiency-level storage diagnosis index is satisfied, the first computing condition is that the invalid-level computing diagnosis index is satisfied, and the second computing condition is that the low-efficiency-level computing diagnosis index is satisfied;
the invalid-level storage diagnosis index includes an index used for representing that the usage rate of stored data is 0, and/or an index used for representing that the stored data does not satisfy a data storage rule; the low-efficiency-level storage diagnosis index includes an index used for representing that the usage rate of the stored data is less than a usage rate threshold, and/or an index used for representing that a storage type of the data does not satisfy a target storage type; the invalid-level computing diagnosis index includes an index used for representing that the efficiency of the output data of the task is less than a first preset efficiency, and/or an index used for representing that the usage rate of the output data of the task is 0; the low-efficiency-level computing diagnosis index includes an index used for representing that the efficiency of the output data of the task is less than a second preset efficiency; the second preset efficiency is better than the first preset efficiency; and
the third obtaining unit 503 includes:
a first determining subunit is configured to determine the index value of the storage evaluation index based on the storage diagnosis index and a corresponding index value; and
a second determining subunit is configured to determine the index value of the computing evaluation index based on the computing diagnosis index and a corresponding index value.

In a possible implementation is the invalid-level storage diagnosis index includes one or more of the following:
a data table is not provided with a time to live, a total number of accesses to the data table within a preset period of time is 0, a total number of accesses to data in a library within the preset period of time is 0, a total number of accesses to data under a directory within the preset period of time is 0, and the time to live of the data table is greater than a recommended value;
the low-efficiency-level storage diagnosis index includes one or more of the following:
a total number of small files is greater than a target number, an access frequency of partitioned data is less than a target frequency, and stored data is not compressed;
the invalid-level computing diagnosis index includes one or more of the following:
a total number of accesses to output by a task within a preset period of time is 0, the task normally ends within the preset period of time but the output is empty, a total number of accesses to a dashboard and/or an interface within the preset period of time is 0, the task fails within the preset period of time, and a usage rate of a task queue on the current day is 0; and
the low-efficiency-level computing diagnosis index includes one or more of the following:
data resource utilization rate is less than target data resource utilization rate, a data skew occurs in the task, task is repeated, a task execution duration is greater than a target duration, a proportion of a blocking duration of the task queue exceeds a target proportion, and a proportion of an overissued duration of the task queue exceeds a target proportion.

In a possible implementation, the first determining subunit includes:
a third determining subunit is configured to determine, based on the invalid-level storage diagnosis index and a corresponding index value, a data storage amount of invalid data in the cluster data resource, and determine, based on the low-efficiency-level storage diagnosis index, a data storage amount of low-efficiency data in the cluster data resource, in which the data storage amount of the invalid data is used for representing the invalid data storage resource cost, and the data storage amount of the low-efficiency data is used for representing the low-efficiency data storage resource cost;
a fourth determining subunit is configured to determine a total data usage storage amount of the cluster data resource, in which the total data usage storage amount is used for representing the data storage resource cost; and
a fifth determining subunit is configured to determine a ratio of the data storage amount of the invalid data to the total storage amount as the ratio of the invalid storage proportion, and determine a ratio of the data storage amount of the low-efficiency data to the total storage amount as the ratio of the low-efficiency storage proportion.

In a possible implementation, the second determining subunit includes:
a sixth determining subunit is configured to determine, based on the invalid-level computing diagnosis index and a corresponding index value, an invalid computing time of the cluster data resource, and determine, based on the low-efficiency-level computing diagnosis index, a low-efficiency computing time of the cluster data resource, in which the invalid computing time is used for representing the invalid data computing resource cost, and the low-efficiency computing time is used for representing the low-efficiency data computing resource cost, and the computing time is obtained from a central processing unit usage computing time and a memory usage computing time;
a seventh determining subunit is configured to determine a total data usage computing time of the cluster data resource, in which the total data usage computing time is used for representing the data computing resource cost; and
an eighth determining subunit is configured to determine a ratio of the invalid computing time to the total data usage computing time as the ratio of the invalid computing proportion, and determine a ratio of the low-efficiency computing time to the total data usage computing time as the ratio of the low-efficiency computing proportion.

In a possible implementation is the apparatus further includes:
a fifth obtaining unit is configured to obtain a storage observation index in the storage evaluation dimension and a computing observation index in the computing evaluation dimension, in which the storage observation index includes an auxiliary judgment type index of the data storage resource cost and/or a data storage resource governance type index, and the computing observation index includes an auxiliary judgment type index of the data computing resource cost and/or a data computing resource governance type index; and
a second evaluating unit is configured to evaluate the data storage resource cost and the data computing resource cost based on the storage observation index and the computing observation index.

In a possible implementation, the storage observation index includes one or more of the following:
a data storage amount increment within adjacent period of time, a sequential growth rate of the data storage amount increment, a sorting result of the data storage amount increment within a preset period of time, a data storage amount of invalid data and/or low-efficiency data that has been governed within the preset period of time, a monetary value corresponding to the data storage amount of the invalid data and/or low-efficiency data that has been governed, a total data storage amount of the invalid data within the preset period of time, and a total data storage amount of the low-efficiency data within the preset period of time; and
the computing observation index includes one or more of the following:
a total number of tasks, an increment of a task amount within adjacent period of time, a sorting result of task execution durations, a computing time governance result within a preset period of time, an invalid computing time to be governed within the preset period of time, a monetary value corresponding to the invalid computing time to be governed within the preset period of time, a low-efficiency computing time to be governed within the preset period of time, and a monetary value corresponding to the low-efficiency computing time to be governed within the preset period of time;
the computing time governance result includes the invalid computing time and/or the low-efficiency computing time that has been governed, and a monetary value corresponding to the invalid computing time and/or the low-efficiency computing time that has been governed.

It should be noted that for specific implementation of each unit in this embodiment, refer to related descriptions in the foregoing method embodiment. The division of the units in this embodiment of the present disclosure is schematic, and is merely a logical function division. In actual implementation, there may be another division manner. Each functional unit in this embodiment of the present disclosure may be integrated into one processing unit, or each of the units may exist alone physically, or two or more units may be integrated into one unit. For example, in the foregoing embodiment, the processing unit and the sending unit may be the same unit, or may be different units. The foregoing integrated unit may be implemented in a form of hardware, or may be implemented in a form of a software functional unit.

Based on the method for evaluating the cost of the cluster data resource provided in the foregoing method embodiment, the present disclosure further provides an electronic device, including: one or more processors; and a storage apparatus having one or more programs stored thereon, where when the one or more programs are executed by the one or more processors, the one or more processors are enabled to implement the method for evaluating the cost of the cluster data resource according to any one of the foregoing embodiments.

Reference is made to FIG. 6 below, which is a schematic structural diagram of an electronic device 600 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a portable android device (PAD), a portable media player (PMP), and a vehicle-mounted terminal (such as a vehicle navigation terminal), and fixed terminals such as a digital television (TV) and a desktop computer. The electronic device 600 shown in FIG. 6 is merely an example, and shall not impose any limitation on the function and scope of use of the embodiments of the present disclosure.

As shown in FIG. 6, the electronic device 600 may include a processing apparatus (such as a central processor, a graphics processor, etc.) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 609 and installed, installed from the storage apparatus 608, or installed from the ROM 602. When the computer program is executed by the processing apparatus 601, the above-mentioned functions defined in the method of the embodiment of the present disclosure are performed.

The electronic device provided in this embodiment of the present disclosure and the method for evaluating the cost of the cluster data resource provided in the foregoing embodiment belong to the same inventive concept. For technical details not described in detail in this embodiment, reference may be made to the foregoing embodiment, and this embodiment and the foregoing embodiment have the same beneficial effects.

Based on the method for evaluating the cost of the cluster data resource provided in the foregoing method embodiment, this embodiment of the present disclosure provides a computer-readable medium having a computer program stored thereon, where when the program is executed by a processor, the method for evaluating the cost of the cluster data resource according to any one of the foregoing embodiments is implemented.

It should be noted that the computer-readable medium described above in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained on the computer-readable medium may be transmitted by any suitable medium, including but not limited to electric wires, optical cables, radio frequency (RF), and the like, or any suitable combination thereof.

In some implementations, the client and the server may communicate by using any currently known or future-developed network protocol such as a Hyper Text Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The foregoing computer-readable medium may be contained in the foregoing electronic device. Alternatively, the computer-readable medium may exist independently, without being assembled into the electronic device.

The foregoing computer-readable medium carries one or more programs that, when executed by the electronic device, cause the electronic device to perform the method for evaluating the cost of the cluster data resource.

The computer program code for performing the operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on a function involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments described in this specification may be implemented by means of software, or may be implemented by means of hardware. The name of a unit/module does not constitute a limitation on the unit in some cases, for example, a speech data acquisition module may alternatively be described as a “data acquisition module”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include but is not limited to electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It should be noted that in this specification, the embodiments are described in a progressive manner, and each embodiment focuses on differences from other embodiments. For the same or similar parts between the embodiments, reference may be made to each other. For a system or apparatus disclosed in the embodiments, since it corresponds to a method disclosed in the embodiments, the description is relatively simple, and for related parts, reference may be made to the description of the method section.

It should be understood that in the present disclosure, “at least one item” means one or more items, and “a plurality of items” means two or more items. “And/or” describes an association relationship between associated objects, and represents that three relationships may exist. For example, “A and/or B” may represent the following three cases: only A exists, only B exists, and both A and B exist, where A and B may be singular or plural. The character “/” generally indicates an “or” relationship between the associated objects. “At least one of the following items (pieces)” or a similar expression thereof means any combination of these items, including a single item (piece) or any combination of a plurality of items (pieces). For example, at least one of a, b, or c, may represent: a, b, c, “a and b”, “a and c”, “b and c”, or “a, b, and c”, where a, b, and c may be singular or plural.

It should also be noted that in this specification, relational terms such as first and second are merely used to distinguish one entity or operation from another entity or operation, and do not necessarily require or imply any such actual relationship or order between these entities or operations. Moreover, the terms “include”, “comprise”, or any other variant thereof are intended to cover non-exclusive inclusion, so that a process, method, article, or apparatus that includes a list of elements not only includes those elements, but also includes other elements not explicitly listed, or further includes elements inherent to such process, method, article, or apparatus. Without more restrictions, an element defined by a statement “including one . . . ” does not exclude the presence of another identical element in the process, method, article, or apparatus that includes the element.

The steps of the method or algorithm described in the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The foregoing descriptions of the disclosed embodiments enable those skilled in the art to implement or use the present disclosure. Various modifications to these embodiments will be readily apparent to those skilled in the art, and the general principles defined herein may be implemented in other embodiments without departing from the spirit or scope of the present disclosure. Therefore, the present disclosure is not intended to be limited to the embodiments shown herein, but is to be consistent with the widest scope consistent with the principles and novel features disclosed herein.

1. A method for evaluating a cost of a cluster data resource, comprising:
obtaining an evaluation dimension for evaluating the cost of the cluster data resource, wherein the cost of the cluster data resource comprises a data storage resource cost and a data computing resource cost, and the evaluation dimension comprises a storage evaluation dimension and a computing evaluation dimension;
obtaining a storage evaluation index in the storage evaluation dimension and a computing evaluation index in the computing evaluation dimension, wherein the storage evaluation index comprises an invalid storage proportion of an invalid data storage resource cost in the data storage resource cost and a low-efficiency storage proportion of a low-efficiency data storage resource cost in the data storage resource cost, and the computing evaluation index comprises an invalid computing proportion of an invalid data computing resource cost in the data computing resource cost and a low-efficiency computing proportion of a low-efficiency data computing resource cost in the data computing resource cost;
obtaining an index value of the storage evaluation index and an index value of the computing evaluation index; and
evaluating the data storage resource cost based on the index value of the storage evaluation index, and evaluating the data computing resource cost based on the index value of the computing evaluation index,
wherein the invalid data storage resource cost is a data storage resource cost that satisfies a first storage condition, the low-efficiency data storage resource cost is a data storage resource cost that satisfies a second storage condition, the invalid data computing resource cost is a data computing resource cost that satisfies a first computing condition, and the low-efficiency data computing resource cost is a data computing resource cost that satisfies a second computing condition.

2. The method according to claim 1, further comprising:
obtaining a storage diagnosis index in the storage evaluation dimension and a computing diagnosis index in the computing evaluation dimension, wherein the storage diagnosis index comprises an invalid-level storage diagnosis index and a low-efficiency-level storage diagnosis index, and the computing diagnosis index comprises an invalid-level computing diagnosis index and a low-efficiency-level computing diagnosis index;
the first storage condition is that the invalid-level storage diagnosis index is satisfied, the second storage condition is that the low-efficiency-level storage diagnosis index is satisfied, the first computing condition is that the invalid-level computing diagnosis index is satisfied, and the second computing condition is that the low-efficiency-level computing diagnosis index is satisfied;
the invalid-level storage diagnosis index comprises an index used for representing that a usage rate of stored data is 0, and/or an index used for representing that the stored data does not satisfy a data storage rule;
the low-efficiency-level storage diagnosis index comprises an index used for representing that a usage rate of the stored data is less than a usage rate threshold, and/or an index used for representing that a storage type of data does not satisfy a target storage type;
the invalid-level computing diagnosis index comprises an index used for representing that data output efficiency of a task is lower than a first preset efficiency, and/or an index used for representing that a usage rate of data output by the task is 0;
the low-efficiency-level computing diagnosis index comprises an index used for representing that the data output efficiency of the task is lower than a second preset efficiency, and the second preset efficiency is better than the first preset efficiency; and
the obtaining an index value of the storage evaluation index and an index value of the computing evaluation index comprises:
determining the index value of the storage evaluation index based on the storage diagnosis index and an index value corresponding to the storage diagnosis index; and
determining the index value of the computing evaluation index based on the computing diagnosis index and an index value corresponding to the computing diagnosis index.

3. The method according to claim 2, wherein the invalid-level storage diagnosis index comprises at least one selected from the group consisting of:
a data table is not provided with a time to live, a total number of accesses to the data table within a preset period of time is 0, a total number of accesses to data in a database within the preset period of time is 0, a total number of accesses to data under a directory within the preset period of time is 0, and a time to live of the data table is greater than a recommended value;
the low-efficiency-level storage diagnosis index comprises at least one selected from the group consisting of:
a total number of small files is greater than a target number, an access frequency of partitioned data is less than a target frequency, and the stored data is not compressed;
the invalid-level computing diagnosis index comprises at least one selected from the group consisting of:
a total number of accesses to output of a task within a preset period of time is 0, the task is normally ended within the preset period of time but the output of the task is empty, a total number of accesses to a dashboard and/or an interface within the preset period of time is 0, the task fails within the preset period of time, and a usage rate of a task queue is 0 on current day; and
the low-efficiency-level computing diagnosis index comprises at least one selected from the group consisting of:
a data resource utilization rate is lower than a target data resource utilization rate, data skew occurs in the task, the task is repeated, a task execution duration is greater than a target duration, a proportion of a blocking duration of the task queue exceeds a first target proportion, and a proportion of an over-issued duration of the task queue exceeds a second target proportion.

4. The method according to claim 2, wherein the determining the index value of the storage evaluation index based on the storage diagnosis index and an index value corresponding to the storage diagnosis index comprises:
determining, based on the invalid-level storage diagnosis index and an index value corresponding to the invalid-level storage diagnosis index, a data storage amount of invalid data in the cluster data resource; determining, based on the low-efficiency-level storage diagnosis index, a data storage amount of low-efficiency data in the cluster data resource, wherein the data storage amount of the invalid data is used for representing the invalid data storage resource cost, and the data storage amount of the low-efficiency data is used for representing the low-efficiency data storage resource cost;
determining a total data usage storage amount in the cluster data resource, wherein the total data usage storage amount is used for representing the data storage resource cost; and
determining a ratio of the data storage amount of the invalid data to the total data storage amount as a ratio of the invalid storage proportion, and determining a ratio of the data storage amount of the low-efficiency data to the total data storage amount as a ratio of the low-efficiency storage proportion.

5. The method according to claim 3, wherein the determining the index value of the storage evaluation index based on the storage diagnosis index and an index value corresponding to the storage diagnosis index comprises:
determining, based on the invalid-level storage diagnosis index and an index value corresponding to the invalid-level storage diagnosis index, a data storage amount of invalid data in the cluster data resource; determining, based on the low-efficiency-level storage diagnosis index, a data storage amount of low-efficiency data in the cluster data resource, wherein the data storage amount of the invalid data is used for representing the invalid data storage resource cost, and the data storage amount of the low-efficiency data is used for representing the low-efficiency data storage resource cost;
determining a total data usage storage amount in the cluster data resource, wherein the total data usage storage amount is used for representing the data storage resource cost; and
determining a ratio of the data storage amount of the invalid data to the total data storage amount as a ratio of the invalid storage proportion, and determining a ratio of the data storage amount of the low-efficiency data to the total data storage amount as a ratio of the low-efficiency storage proportion.

6. The method according to claim 2, wherein the determining the index value of the computing evaluation index based on the computing diagnosis index and an index value corresponding to the computing diagnosis index comprises:
determining, based on the invalid-level computing diagnosis index and an index value corresponding to the invalid-level computing diagnosis index, an invalid computing time of the cluster data resource; and determining, based on the low-efficiency-level computing diagnosis index, a low-efficiency computing time of the cluster data resource, wherein the invalid computing time is used for representing the invalid data computing resource cost, the low-efficiency computing time is used for representing the low-efficiency data computing resource cost, and the computing time is obtained from a central processing unit usage computing time and a memory usage computing time;
determining a total data usage computing time of the cluster data resource, wherein the total data usage computing time is used for representing the data computing resource cost; and
determining a ratio of the invalid computing time to the total data usage computing time as a ratio of the invalid computing proportion, and determining a ratio of the low-efficiency computing time to the total data usage computing time as a ratio of the low-efficiency computing proportion.

7. The method according to claim 3, wherein the determining the index value of the computing evaluation index based on the computing diagnosis index and an index value corresponding to the computing diagnosis index comprises:
determining, based on the invalid-level computing diagnosis index and an index value corresponding to the invalid-level computing diagnosis index, an invalid computing time of the cluster data resource; and determining, based on the low-efficiency-level computing diagnosis index, a low-efficiency computing time of the cluster data resource, wherein the invalid computing time is used for representing the invalid data computing resource cost, the low-efficiency computing time is used for representing the low-efficiency data computing resource cost, and the computing time is obtained from a central processing unit usage computing time and a memory usage computing time;
determining a total data usage computing time of the cluster data resource, wherein the total data usage computing time is used for representing the data computing resource cost; and
determining a ratio of the invalid computing time to the total data usage computing time as a ratio of the invalid computing proportion, and determining a ratio of the low-efficiency computing time to the total data usage computing time as a ratio of the low-efficiency computing proportion.

8. The method according to claim 1, further comprising:
obtaining a storage observation index in the storage evaluation dimension and a computing observation index in the computing evaluation dimension, wherein the storage observation index comprises an auxiliary judgment type index and/or a data storage resource governance type index of the data storage resource cost, and the computing observation index comprises an auxiliary judgment type index and/or a data computing resource governance type index of the data computing resource cost; and
evaluating the data storage resource cost and the data computing resource cost in combination with the storage observation index and the computing observation index.

9. The method according to claim 8, wherein the storage observation index comprises at least one selected from the group consisting of:
a data storage amount increment within adjacent period of time, a sequential growth rate of the data storage amount increment, a sorting result of the data storage amount increment within a preset period of time, a data storage amount of invalid data and/or low-efficiency data that has been governed within the preset period of time, a monetary value corresponding to the data storage amount of the invalid data and/or the low-efficiency data that has been governed, a total data storage amount of the invalid data within the preset period of time, and a total data storage amount of the low-efficiency data within the preset period of time; and
the computing observation index comprises at least one selected from the group consisting of:
a total number of tasks, an increment of a task amount within adjacent period of time, a sorting result of task execution duration, a computing time governance result within the preset period of time, an invalid computing time to be governed within the preset period of time, a monetary value corresponding to the invalid computing time to be governed within the preset period of time, a low-efficiency computing time to be governed within the preset period of time, and a monetary value corresponding to the low-efficiency computing time to be governed within the preset period of time; and
the computing time governance result comprises an invalid computing time and/or a low-efficiency computing time that has been governed, and a monetary value corresponding to the invalid computing time and/or the low-efficiency computing time that has been governed.

10. A non-transitory computer-readable storage medium, having a computer program stored thereon, wherein the computer program, when executed by a processor, implements a method for evaluating a cost of a cluster data resource, and the method comprises:
obtaining an evaluation dimension for evaluating the cost of the cluster data resource, wherein the cost of the cluster data resource comprises a data storage resource cost and a data computing resource cost, and the evaluation dimension comprises a storage evaluation dimension and a computing evaluation dimension;
obtaining a storage evaluation index in the storage evaluation dimension and a computing evaluation index in the computing evaluation dimension, wherein the storage evaluation index comprises an invalid storage proportion of an invalid data storage resource cost in the data storage resource cost and a low-efficiency storage proportion of a low-efficiency data storage resource cost in the data storage resource cost, and the computing evaluation index comprises an invalid computing proportion of an invalid data computing resource cost in the data computing resource cost and a low-efficiency computing proportion of a low-efficiency data computing resource cost in the data computing resource cost;
obtaining an index value of the storage evaluation index and an index value of the computing evaluation index; and
evaluating the data storage resource cost based on the index value of the storage evaluation index, and evaluating the data computing resource cost based on the index value of the computing evaluation index,
wherein the invalid data storage resource cost is a data storage resource cost that satisfies a first storage condition, the low-efficiency data storage resource cost is a data storage resource cost that satisfies a second storage condition, the invalid data computing resource cost is a data computing resource cost that satisfies a first computing condition, and the low-efficiency data computing resource cost is a data computing resource cost that satisfies a second computing condition.

11. The non-transitory computer-readable storage medium according to claim 10, and the method further comprises:
obtaining a storage diagnosis index in the storage evaluation dimension and a computing diagnosis index in the computing evaluation dimension, wherein the storage diagnosis index comprises an invalid-level storage diagnosis index and a low-efficiency-level storage diagnosis index, and the computing diagnosis index comprises an invalid-level computing diagnosis index and a low-efficiency-level computing diagnosis index;
the first storage condition is that the invalid-level storage diagnosis index is satisfied, the second storage condition is that the low-efficiency-level storage diagnosis index is satisfied, the first computing condition is that the invalid-level computing diagnosis index is satisfied, and the second computing condition is that the low-efficiency-level computing diagnosis index is satisfied;
the invalid-level storage diagnosis index comprises an index used for representing that a usage rate of stored data is 0 and/or an index used for representing that the stored data does not satisfy a data storage rule;
the low-efficiency-level storage diagnosis index comprises an index used for representing that a usage rate of the stored data is less than a usage rate threshold and/or an index used for representing that a storage type of data does not satisfy a target storage type;
the invalid-level computing diagnosis index comprises an index used for representing that data output efficiency of a task is lower than a first preset efficiency and/or an index used for representing that a usage rate of data output by the task is 0;
the low-efficiency-level computing diagnosis index comprises an index used for representing that the data output efficiency of the task is lower than a second preset efficiency; and the second preset efficiency is better than the first preset efficiency; and
the obtaining an index value of the storage evaluation index and an index value of the computing evaluation index comprises:
determining the index value of the storage evaluation index based on the storage diagnosis index and an index value corresponding to the storage diagnosis index; and
determining the index value of the computing evaluation index based on the computing diagnosis index and an index value corresponding to the computing diagnosis index.

12. The non-transitory computer-readable storage medium according to claim 11, wherein the invalid-level storage diagnosis index comprises at least one selected from the group consisting of:
a data table is not provided with a time to live, a total number of accesses to the data table within a preset period of time is 0, a total number of accesses to data in a database within the preset period of time is 0, a total number of accesses to data under a directory within the preset period of time is 0, and a time to live of the data table is greater than a recommended value;
the low-efficiency-level storage diagnosis index comprises at least one selected from the group consisting of:
a total number of small files is greater than a target number, an access frequency of partitioned data is less than a target frequency, and the stored data is not compressed;
the invalid-level computing diagnosis index comprises at least one selected from the group consisting of:
a total number of accesses to output of a task within a preset period of time is 0, the task is normally ended within the preset period of time but the output of the task is empty, a total number of accesses to a dashboard and/or an interface within the preset period of time is 0, the task fails within the preset period of time, and a usage rate of a task queue is 0 on current day; and
the low-efficiency-level computing diagnosis index comprises at least one selected from the group consisting of:
a data resource utilization rate is lower than a target data resource utilization rate, data skew occurs in the task, the task is repeated, a task execution duration is greater than a target duration, a proportion of a blocking duration of the task queue exceeds a first target proportion, and a proportion of an over-issued duration of the task queue exceeds a second target proportion.

13. The non-transitory computer-readable storage medium according to claim 11, wherein the determining the index value of the storage evaluation index based on the storage diagnosis index and an index value corresponding to the storage diagnosis index comprises:
determining, based on the invalid-level storage diagnosis index and an index value corresponding to the invalid-level storage diagnosis index, a data storage amount of invalid data in the cluster data resource; determining, based on the low-efficiency-level storage diagnosis index, a data storage amount of low-efficiency data in the cluster data resource, wherein the data storage amount of the invalid data is used for representing the invalid data storage resource cost, and the data storage amount of the low-efficiency data is used for representing the low-efficiency data storage resource cost;
determining a total data usage storage amount in the cluster data resource, wherein the total data usage storage amount is used for representing the data storage resource cost; and
determining a ratio of the data storage amount of the invalid data to the total data storage amount as a ratio of the invalid storage proportion, and determining a ratio of the data storage amount of the low-efficiency data to the total data storage amount as a ratio of the low-efficiency storage proportion.

14. An electronic device, comprising:
at least one processor; and
a storage apparatus having at least one program stored thereon,
wherein the at least one program, when executed by the at least one processor, cause the at least one processor to implement a method for evaluating a cost of a cluster data resource, and the method comprises:
obtaining an evaluation dimension for evaluating the cost of the cluster data resource, wherein the cost of the cluster data resource comprises a data storage resource cost and a data computing resource cost, and the evaluation dimension comprises a storage evaluation dimension and a computing evaluation dimension;
obtaining a storage evaluation index in the storage evaluation dimension and a computing evaluation index in the computing evaluation dimension, wherein the storage evaluation index comprises an invalid storage proportion of an invalid data storage resource cost in the data storage resource cost and a low-efficiency storage proportion of a low-efficiency data storage resource cost in the data storage resource cost, and the computing evaluation index comprises an invalid computing proportion of an invalid data computing resource cost in the data computing resource cost and a low-efficiency computing proportion of a low-efficiency data computing resource cost in the data computing resource cost;
obtaining an index value of the storage evaluation index and an index value of the computing evaluation index; and
evaluating the data storage resource cost based on the index value of the storage evaluation index, and evaluating the data computing resource cost based on the index value of the computing evaluation index,
wherein the invalid data storage resource cost is a data storage resource cost that satisfies a first storage condition, the low-efficiency data storage resource cost is a data storage resource cost that satisfies a second storage condition, the invalid data computing resource cost is a data computing resource cost that satisfies a first computing condition, and the low-efficiency data computing resource cost is a data computing resource cost that satisfies a second computing condition.

15. The electronic device according to claim 14, and the method further comprises:
obtaining a storage diagnosis index in the storage evaluation dimension and a computing diagnosis index in the computing evaluation dimension, wherein the storage diagnosis index comprises an invalid-level storage diagnosis index and a low-efficiency-level storage diagnosis index, and the computing diagnosis index comprises an invalid-level computing diagnosis index and a low-efficiency-level computing diagnosis index;
the first storage condition is that the invalid-level storage diagnosis index is satisfied, the second storage condition is that the low-efficiency-level storage diagnosis index is satisfied, the first computing condition is that the invalid-level computing diagnosis index is satisfied, and the second computing condition is that the low-efficiency-level computing diagnosis index is satisfied;
the invalid-level storage diagnosis index comprises an index used for representing that a usage rate of stored data is 0 and/or an index used for representing that the stored data does not satisfy a data storage rule;
the low-efficiency-level storage diagnosis index comprises an index used for representing that a usage rate of the stored data is less than a usage rate threshold and/or an index used for representing that a storage type of data does not satisfy a target storage type;
the invalid-level computing diagnosis index comprises an index used for representing that data output efficiency of a task is lower than a first preset efficiency and/or an index used for representing that a usage rate of data output by the task is 0;
the low-efficiency-level computing diagnosis index comprises an index used for representing that the data output efficiency of the task is lower than a second preset efficiency; and
the second preset efficiency is better than the first preset efficiency; and
the obtaining an index value of the storage evaluation index and an index value of the computing evaluation index comprises:
determining the index value of the storage evaluation index based on the storage diagnosis index and an index value corresponding to the storage diagnosis index; and
determining the index value of the computing evaluation index based on the computing diagnosis index and an index value corresponding to the computing diagnosis index.

16. The electronic device according to claim 15, wherein the invalid-level storage diagnosis index comprises at least one selected from the group consisting of:
a data table is not provided with a time to live, a total number of accesses to the data table within a preset period of time is 0, a total number of accesses to data in a database within the preset period of time is 0, a total number of accesses to data under a directory within the preset period of time is 0, and a time to live of the data table is greater than a recommended value;
the low-efficiency-level storage diagnosis index comprises at least one selected from the group consisting of:
a total number of small files is greater than a target number, an access frequency of partitioned data is less than a target frequency, and the stored data is not compressed;
the invalid-level computing diagnosis index comprises at least one selected from the group consisting of:
a total number of accesses to output of a task within a preset period of time is 0, the task is normally ended within the preset period of time but the output of the task is empty, a total number of accesses to a dashboard and/or an interface within the preset period of time is 0, the task fails within the preset period of time, and a usage rate of a task queue is 0 on current day; and
the low-efficiency-level computing diagnosis index comprises at least one selected from the group consisting of:
a data resource utilization rate is lower than a target data resource utilization rate, data skew occurs in the task, the task is repeated, a task execution duration is greater than a target duration, a proportion of a blocking duration of the task queue exceeds a first target proportion, and a proportion of an over-issued duration of the task queue exceeds a second target proportion.

17. The electronic device according to claim 15, wherein the determining the index value of the storage evaluation index based on the storage diagnosis index and an index value corresponding to the storage diagnosis index comprises:
determining, based on the invalid-level storage diagnosis index and an index value corresponding to the invalid-level storage diagnosis index, a data storage amount of invalid data in the cluster data resource; determining, based on the low-efficiency-level storage diagnosis index, a data storage amount of low-efficiency data in the cluster data resource, wherein the data storage amount of the invalid data is used for representing the invalid data storage resource cost, and the data storage amount of the low-efficiency data is used for representing the low-efficiency data storage resource cost;
determining a total data usage storage amount in the cluster data resource, wherein the total data usage storage amount is used for representing the data storage resource cost; and
determining a ratio of the data storage amount of the invalid data to the total data storage amount as a ratio of the invalid storage proportion, and determining a ratio of the data storage amount of the low-efficiency data to the total data storage amount as a ratio of the low-efficiency storage proportion.

18. The electronic device according to claim 15, wherein the determining the index value of the computing evaluation index based on the computing diagnosis index and an index value corresponding to the computing diagnosis index comprises:
determining, based on the invalid-level computing diagnosis index and an index value corresponding to the invalid-level computing diagnosis index, an invalid computing time of the cluster data resource; and determining, based on the low-efficiency-level computing diagnosis index, a low-efficiency computing time of the cluster data resource, wherein the invalid computing time is used for representing the invalid data computing resource cost, and the low-efficiency computing time is used for representing the low-efficiency data computing resource cost, and the computing time is obtained from a central processing unit usage computing time and a memory usage computing time;
determining a total data usage computing time of the cluster data resource, wherein the total data usage computing time is used for representing the data computing resource cost; and
determining a ratio of the invalid computing time to the total data usage computing time as a ratio of the invalid computing proportion, and determining a ratio of the low-efficiency computing time to the total data usage computing time as a ratio of the low-efficiency computing proportion.

19. The electronic device according to claim 14, and the method further comprises:
obtaining a storage observation index in the storage evaluation dimension and a computing observation index in the computing evaluation dimension, wherein the storage observation index comprises an auxiliary judgment type index and/or a data storage resource governance type index of the data storage resource cost, and the computing observation index comprises an auxiliary judgment type index and/or a data computing resource governance type index of the data computing resource cost; and
evaluating the data storage resource cost and the data computing resource cost in combination with the storage observation index and the computing observation index.

20. The electronic device according to claim 19, wherein the storage observation index comprises at least one selected from the group consisting of:
a data storage amount increment within adjacent period of time, a sequential growth rate of the data storage amount increment, a sorting result of the data storage amount increment within a preset period of time, a data storage amount of invalid data and/or low-efficiency data that has been governed within the preset period of time, a monetary value corresponding to the data storage amount of the invalid data and/or the low-efficiency data that has been governed, a total data storage amount of the invalid data within the preset period of time, and a total data storage amount of the low-efficiency data within the preset period of time; and
the computing observation index comprises at least one selected from the group consisting of:
a total number of tasks, an increment of a task amount within adjacent period of time, a sorting result of task execution duration, a computing time governance result within the preset period of time, an invalid computing time to be governed within the preset period of time, a monetary value corresponding to the invalid computing time to be governed within the preset period of time, a low-efficiency computing time to be governed within the preset period of time, and a monetary value corresponding to the low-efficiency computing time to be governed within the preset period of time; and
the computing time governance result comprises an invalid computing time and/or a low-efficiency computing time that has been governed, and a monetary value corresponding to the invalid computing time and/or the low-efficiency computing time that has been governed.
